(19) United States
(12) Patent Application Publication
(10) Pub. No.: US 2012/0206584 A1
(43) Pub. Date: Aug. 16, 2012

(54) INTEGRATED INPUT INTERFACE

(75) Inventors: Takafumi SERIZAWA, Ama-Gun (JP); Yasuyuki YANAGIDA, Nagoya (JP)

(73) Assignee: Meijo University, Nagoya (JP)

(21) Appl. No.: 13/368,766

(22) Filed: Feb. 8, 2012

Related U.S. Application Data
(60) Provisional application No. 61/441,327, filed on Feb. 10, 2011.

(51) Int. Cl. H04N 7/18

(52) U.S. Cl. 348/77; 348/E07.085

(57) ABSTRACT

An information processing apparatus 10 includes an input device 20, a computer 30, and a display 40. The input device 20 is provided so that a dome-shaped operation cover 25 covers an image capturing device included in the input device 20. The computer 30 recognizes a pressing digit that has pressed the operation cover 25 based on a color image of an entire hand which has been captured by the image capturing device, and generates a set command based on the pressing digit. The computer 30 also recognizes an approaching digit that is approaching the operation cover 25 based on the color image, and generates a pre-announcement command based on the digit. The computer 30 executes a process corresponding to each of the commands.

The present application claims priority on the basis of the U.S. Provisional Patent Application No. 61/441,327 filed on Feb. 10, 2011, the entire contents of which are incorporated herein by reference.

### BACKGROUND OF THE INVENTION

1. Field of the Invention

The present invention relates to an integrated input interface.

2. Description of the Related Art

Keyboards and mice have been hitherto known as user interface devices. In recent years, user interface devices operated while being gripped by a person's hand have been reported. For example, PTL 1 discloses a user interface device including an outer shell that is formed of a resilient material, an image capturing device that is located inside the outer shell and that photographs the hand and digits of an operator who grips the outer shell with their hand and digits, and a variation recognition device that recognizes variations in the positions and postures of the hand and digits among images captured by the image capturing device. A command for a mouse is generated by the user interface device recognizing the pressure value of the index finger based on the positions and postures of the hand and digits. When the pressure value is less than or equal to a threshold, a command corresponding to a normal grip is generated, and, when the pressure value exceeds the threshold, a command corresponding to, for example, a left click of the mouse is generated. For the middle finger, likewise, a command corresponding to a right click of the mouse is generated.

### CITATION LIST

### Patent Literature

[PTL 1] Japanese Unexamined Patent Application Publication No. 2005-165670

### SUMMARY OF THE INVENTION

In PTL 1, since a command corresponding to a click is generated based on the pressure value of a digit that has touched the outer shell, no command is generated until a digit has touched the outer shell. Therefore, for example, if an operator who wishes to input a desired character by touching a given position on the outer shell with their finger unintentionally touches a different position with their digit, the operator does not recognize the incorrect operation until a character different from the desired character has been input after the digit touched the outer shell. In this case, there is a need to delete the character that has been input and thereafter input again a correct character, resulting in low operability.

The present invention has been made in order to overcome the foregoing problems, and it is an object thereof to allow improvement in operability for the operator in an integrated input interface including an operation cover having an outer surface which can be touched with the entire human hand.

An integrated input interface of the present invention includes: an image capturing device capable of capturing a color image; a light-transmissive operation cover disposed so as to cover the image capturing device, the operation cover having an outer surface which can be touched by an operator with an entire hand of the operator; a command generator for recognizing a pressing digit that has pressed the outer surface, based on a color image of the entire hand which has been captured by the image capturing devise, and generating a set command based on the pressing digit, and also for recognizing an approaching digit that is approaching the outer surface, based on a color image of the entire hand which has been captured by the image capturing device, regarding the approaching digit as an intended pressing digit, and generating a pre-announcement command based on the intended pressing digit; and a processor for executing a process corresponding to the set command when the command generator generates the set command, and for executing a pre-announcement process for pre-announcing that the process corresponding to the set command is to be executed when the command generator generates the pre-announcement command.

In this integrated input interface, a set command is generated based on a pressing digit that has pressed the outer surface of the operation cover. In contrast, a digit that is approaching the outer surface of the operation cover is regarded as an intended pressing digit, and a pre-announcement command is generated based on the intended pressing digit. The pre-announcement command is a command for executing a pre-announcement process. The term pre-announcement process is used to refer to a process for pre-announcing that a process corresponding to a set command generated when an intended pressing digit itself has pressed the outer surface of the operation cover is to be executed. Thus, an operator is able to know what process will be executed if the operator continues pressing the operation cover with their digit while making their digit more closely approach the outer surface of the operation cover. Therefore, operability for the operator is improved.

In the integrated input interface according to the present invention, the command generator may recognize the pressing digit and the intended pressing digit by utilizing a predetermined relationship between at least one parameter out of a brightness, saturation, and edge clarity of a digit and a distance from the outer surface to the digit and also by utilizing an interval time during which the color image is captured. This enables accurate determination of whether a digit is pressing the outer surface of the operation cover and whether a digit is approaching the outer surface.

In the integrated input interface according to the present invention, the command generator may calculate a position on the outer surface which has been pressed by the pressing digit, and generate a set command based on the pressing digit and the position. Meanwhile, the command generator may also determine an estimated position on the outer surface which is estimated to be pressed by the intended pressing digit, and generate a pre-announcement command based on the intended pressing digit and the estimated position. This can increase the number of commands compared with a case where a set command and a pre-announcement command are generated irrespective of the position on the outer surface of the operation cover.

In the integrated input interface according to the present invention, when there are a plurality of the approaching digits, the command generator may determine a distance between each of the approaching digits and the outer surface, and regard a digit having the smallest distance as the intended pressing digit, or may calculate a predicted touch time based on an approaching speed of each of the approaching digits, and regard a digit having the shortest predicted touch time as the intended pressing digit. This enables accurate determination of a digit with which an operator is to press the outer surface of the operation cover in the next operation even if there are a plurality of approaching digits. Here, if there are a plurality of the approaching digits having equivalent distances to the outer surface, the command generator may determine an approaching speed of each of the approaching digits, and regard a digit having the highest approaching speed as the intended pressing digit. This enables more accurate determination of a digit with which the operator is to press the outer surface of the operation cover in the next operation. A digit having the shortest distance (that is, height) to the outer surface may be determined by using the absolute heights of digits or using the relative heights of digits. In addition, a digit having the highest approaching speed may be determined by using a speed determined based on the absolute heights of digits or using a speed determined based on the relative heights of digits. Preferably, the relative heights of digits are used because the relative heights of digits are less affected by individual differences than the absolute heights of digits. When the absolute heights of digits are used, preferably, the absolute heights are determined based on changes in edge clarity of the digits. This is because the changes in edge clarity of digits are comparatively less affected by individual differences.

The integrated input interface according to the present invention may further include an output device capable of outputting at least a character. The processor may set a virtual keyboard over the operation cover. When the command generator generates the set command, the processor may output a character on the virtual keyboard corresponding to a pressing digit and a pressed position included in the set command to the output device in a predetermined form. When the command generator generates the pre-announcement command, the processor may output a character on the virtual keyboard corresponding to an intended pressing digit and an estimated position included in the pre-announcement command to the output device in a form different from the predetermined form. Here, the output device may be display output device such as a display or audio output device such as a speaker. The virtual keyboard may be configured using a key layout of an existing keyboard as it is, or may be placed so that, for example, a character group to be operated with the index finger, a character group to be operated with the middle finger, and a character group to be operated with the ring finger overlap. The virtual keyboard may also be configured to keep track of the position of the entire hand placed on the operation cover before a character is started to be input. This enables an operator to perform keyboard input without having to pay attention to the positional relationship between the operation cover and their hand.

In the integrated input interface according to the present invention, the command generator may convert pixel data of a color image of an entire human hand which has been captured by the image capturing device into likelihood defined to increase as hue becomes closer to a standard skin color and as brightness and saturation increase, and recognize the hand and digits from a likelihood image created based on the likelihood. Thus, a likelihood image of a hand exhibits a high value around the center lines of the digits and around the center of the palm regardless of touch or non-touch. Consequently, for example, even if two digits are placed together with any space therebetween, each digit can be easily recognized by keeping track of pixels having peaks of likelihood.

Here, when recognizing each digit from the likelihood image, the command generator may search for pixels having peaks of likelihood on a circumference of each of a plurality of concentric circles drawn so as to have their centers at a predetermined point on a palm in the likelihood image, may create four finger center lines connecting pixel groups having peaks of likelihood which are arranged radially outward from the predetermined point, may calculate two candidate base positions of the thumb based on two finger center lines at either side out of the four finger center lines, may search for a pixel having a peak of likelihood on a circumference of each of a plurality of concentric circles drawn so as to have their centers at each of the two candidate base positions of the thumb, may recognize a digit center line connecting the searched pixels having peaks of likelihood to be the thumb, and may assign, based on the recognized thumb, the four finger center lines to an index finger, a middle finger, a ring finger, and a little finger.

In the integrated input interface according to the present invention, preferably, the operation cover is formed in a dome shape, and has an inner surface that is a smooth surface, and the outer surface that is a surface having small irregularities like a ground glass. Thus, due to the dome shape, the operation cover can be easily touched with the entire hand. Additionally, since the inner surface is a smooth surface and the outer surface is a surface having small irregularities like a ground glass, when a digit is touching the operation cover, a clear image of the digit can be obtained, and, when a digit is separated from the operation cover, a blurred image of the digit can be obtained. Therefore, both states are easily distinguished from each other.

An integrated input interface according to another aspect, which is different from the integrated input interface according to the present invention, includes: image capturing device capable of capturing a color image; a light-transmissive operation cover disposed so as to cover the image capturing device, the operation cover having an outer surface which can be touched with an entire human hand; table storage for storing a likelihood table that is defined such that color data closer to a standard skin color representing human skin has a higher likelihood; and digit recognizing device for converting pixel data of a color image of an entire human hand which has been captured by the image capturing device into pixel data of likelihood in the light of the likelihood table, creating simulated digit lines using the converted pixel data of likelihood by connecting pixel groups having peaks of likelihood which are arranged radially outward from the center of the palm, and recognizing each digit by utilizing the created simulated digit line.

### BRIEF DESCRIPTION OF THE DRAWINGS

FIG. 1 is an explanatory diagram illustrating an overall configuration of an information processing apparatus 10,

FIG. 2 is a cross-sectional view of an input device 20,

FIG. 3 is a flowchart illustrating an example of an image capture routine,

FIG. 4 is a flowchart illustrating an example of an information processing routine,

FIG. 5 illustrates an image used to explain step S120 in the information processing routine,

FIG. 6 illustrates an image used to explain step S130 in the information processing routine,

FIG. 7 illustrates an image used to explain step S140 in the information processing routine,

FIG. 8 is a chart to aid recognition of the four fingers, with the horizontal axis representing angle and the vertical axis representing likelihood,

FIG. 9 illustrates an image used to explain step S140 in the information processing routine,

FIG. 10 illustrates an image used to explain step S160 in the information processing routine,

FIG. 11 illustrates an image used to explain step S170 in the information processing routine,

FIG. 12 includes charts to aid recognition of the thumb, with the horizontal axis representing angle and the vertical axis representing likelihood, in which part (a) of FIG. 12 is a chart obtained when the left candidate base of the thumb is used and part (b) of FIG. 12 is a chart obtained when the right candidate base of the thumb is used,

FIG. 13 illustrates an image used to explain step S170 in the information processing routine,

FIG. 14 illustrates an image used to explain step S200 in the information processing routine,

FIG. 15 includes graphs representing hue, brightness, saturation, and edge characteristics of a digit,

FIG. 16 includes conceptual diagrams used to explain step S215 in the information processing routine,

FIG. 17 is an explanatory diagram when pressure is applied with a rolling digit,

FIG. 18 includes explanatory diagrams of a screen when a number output program is performed,

FIG. 19 includes explanatory diagrams of a screen when a character output program is performed, and

FIG. 20 includes explanatory diagrams of input modes, in which part (a) of FIG. 20 illustrates a character input mode, part (b) of FIG. 20 illustrates a 2D input mode, and part (c) of FIG. 20 illustrates a 3D input mode.

### DESCRIPTION OF THE PREFERRED EMBODIMENTS

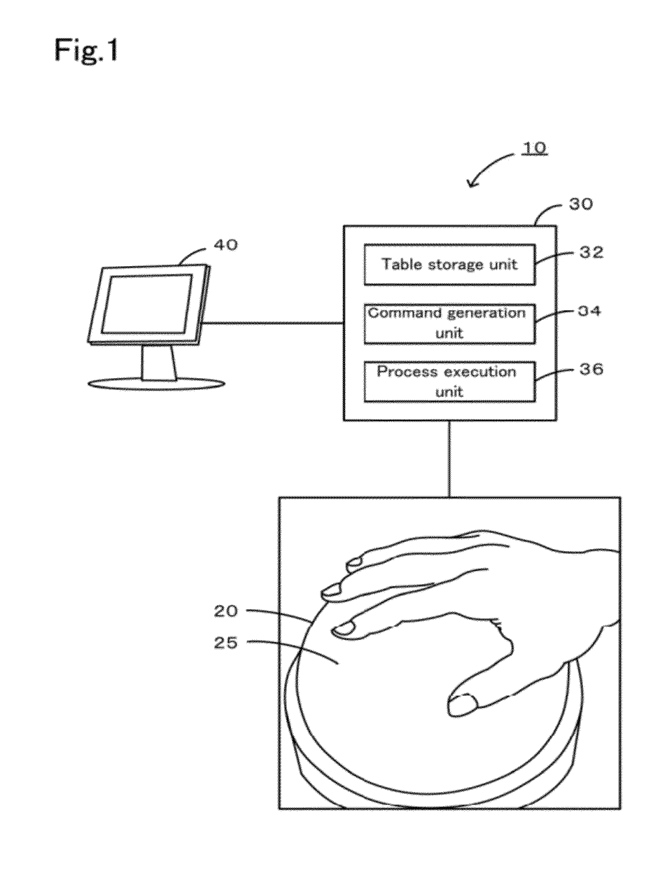

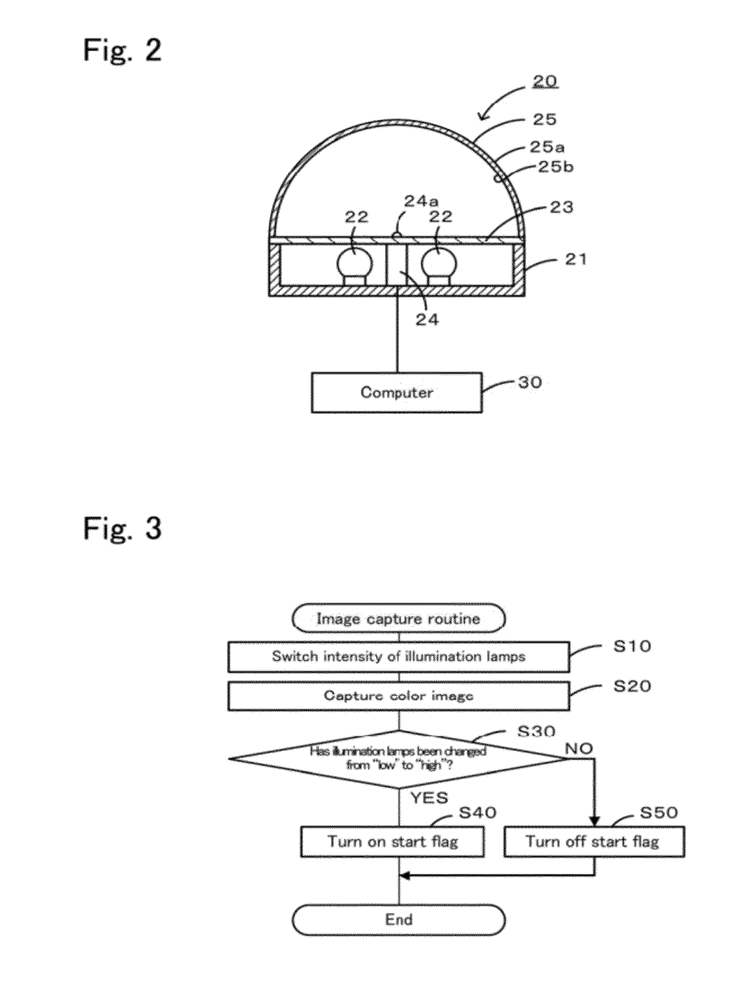

Next, an embodiment of the present invention will be described using the drawings. FIG. 1 is an explanatory diagram illustrating an overall configuration of an information processing apparatus 10 that is an embodiment of an integrated input interface according to the present invention, and FIG. 2 is a cross-sectional view of the input device 20.

As illustrated in FIG. 1, the information processing apparatus 10 of this embodiment includes an input device 20 that generates a signal in accordance with a user operation, a computer 30 that receives the signal from the input device 20 and that executes various control operations, and a display 40 that receives the signal from the computer 30 and that displays characters, figures, etc.

As illustrated in FIG. 2, the input device 20 includes a support base 21 formed in a cylindrical shape having a bottom, a plurality of illumination lamps 22 arranged on the bottom surface of the support base 21, a diffusion plate 23 that covers the upper surface of the support base 21, an image capturing device 24 disposed in the center of the support base 21, and a dome-shaped operation cover 25 that covers the diffusion plate 23. Here, the illumination lamps 22 are disposed so as to emit light to the diffusion plate 23. The diffusion plate 23 diffuses the light emitted from the illumination lamps 22 to substantially uniformly illuminate the interior surface of the operation cover 25. The image capturing device 24 has a fisheye lens 24a which projects upward from a hole formed in the center of the diffusion plate 23, and is designed to output a color image captured onto a CCD imaging element (not illustrated) through the fisheye lens 24a to the computer 30. The operation cover 25 is provided so as to cover the fisheye lens 24a of the image capturing device 24, and has an outer surface 25a which can be touched by the operator with their entire hand (that is, the five digits and the palm). The operation cover 25 is made of a light-transmissive material, and has an inner surface 25b that is a smooth surface and the outer surface 25a that is a surface having small irregularities like a ground glass. Thus, when the hand of the operator is separated from the outer surface 25a, the five digits and the palm appear blurred in the color image obtained by the image capturing device 24. When the operator is touching the outer surface 25a with their hand, the five digits and the palm appear clearly in the color image obtained by the image capturing device 24.

The computer 30 is a known device including a CPU that executes various arithmetic operations, a ROM that stores various programs, tables, etc., a RAM that temporarily stores data, and other devices. The computer 30 may be illustrated by functional blocks: a table storage unit 32, a command generation unit 34, and a process execution unit 36. The table storage unit 32 stores a likelihood table that is defined such that the likelihood increases as hue becomes closer to a standard skin color and as brightness and saturation increase. In this embodiment, likelihood is represented by the sum of the value of brightness, the value of saturation, and the value of hue which has a normal distribution with respect to the standard skin color. The standard skin color as referred herein is assumed to have values of hue at the fifth to thirty-fifth positions starting from red as the origin point (zero) toward green when a hue circle going from red to green to blue and then back to red is separated into 360 regions. When pixel data of the color image is represented by RGB values, the RGB values are converted into HSV values to obtain hue (H), saturation (S), and brightness (V). This conversion method is well known, and a description thereof is thus omitted here. The HSV values can be converted into likelihood on the basis of the likelihood table. It is well established that the color of hairless portions such as the palms or the soles of the feet does not significantly differ with ethnicity. For this reason, there is no need to change the standard skin color for different regions and ethnicities. Depending on the situation, however, such a change may be allowed. The command generation unit 34 analyzes a color image of the entire hand which has been captured by the image capturing device 24 to recognize the respective digits and also recognize the positions of the digits, and generates a set command or a pre-announcement command based on the results. When analyzing the color image to recognize the respective digits, the command generation unit 34 converts the pixel data of the color image of the entire human hand into pixel data of likelihood on the basis of the likelihood table, and generates a command using the resulting pixel data of the likelihood (image of likelihood). When the command generation unit 34 generates a set command, the process execution unit 36 executes the process corresponding to the set command, and, when the command generation unit 34 generates a pre-announcement command, the process execution unit 36 executes a pre-announcement process for pre-announcing that the process corresponding to the set command is to be executed.

The display 40 is a known color liquid crystal display whose display operation is controlled by the computer 30.

Next, the specific operation of the information processing apparatus 10 described above will be described. First, a process for capturing a color image from the image capturing device 24 will be described. FIG. 3 is a flowchart illustrating an example of an image capture routine. A program for executing the image capture routine is stored in the ROM of the computer 30. The computer 30 executes the image capture routine at each predetermined timing (for example, every several msec). When this routine is started, first, the computer 30 switches the intensity of the illumination lamps 22 (step S10). That is, the intensity of the illumination lamps 22 is currently set to “high” when the intensity of the illumination lamps 22 is previously “low”, and is currently set to “low” when it is previously “high”. “Low” represents a brightness that is sufficiently high to allow recognition of the hand when the hand is separated from the outer surface 25a of the operation cover 25 by a maximum recognition distance (of, for example, 15 cm), and “high” may be higher than the “low” and represents a brightness that is, for example, twice or more that represented by “low”. It is preferable because the larger the difference between high intensity and low intensity, the higher the accuracy of distance estimation. Subsequently, the image capturing device 24 is operated to capture a color image, and the color image is stored in the RAM (step S20). The color image is a set of pixel data elements represented by RGB values. Each color of RGB is represented by a numerical value of 0 to 255. After that, it is determined whether or not the intensity of the illumination lamps 22 has been changed from “low” to “high” in step S10 (step S30). If an affirmative determination is made in step S30, a start flag is turned on (step S40), and the routine ends. The start flag is used to determine whether or not to start an information processing routine described below. If a negative determination is made in step S30, the start flag is turned off (step S50), and the routine ends. Consequently, when the start flag is turned on, the currently captured color image (color image obtained when the intensity of the illumination lamps 22 is “high”) and the previously captured color image (color image obtained when the intensity of the illumination lamps 22 is “low”) are stored in the RAM.

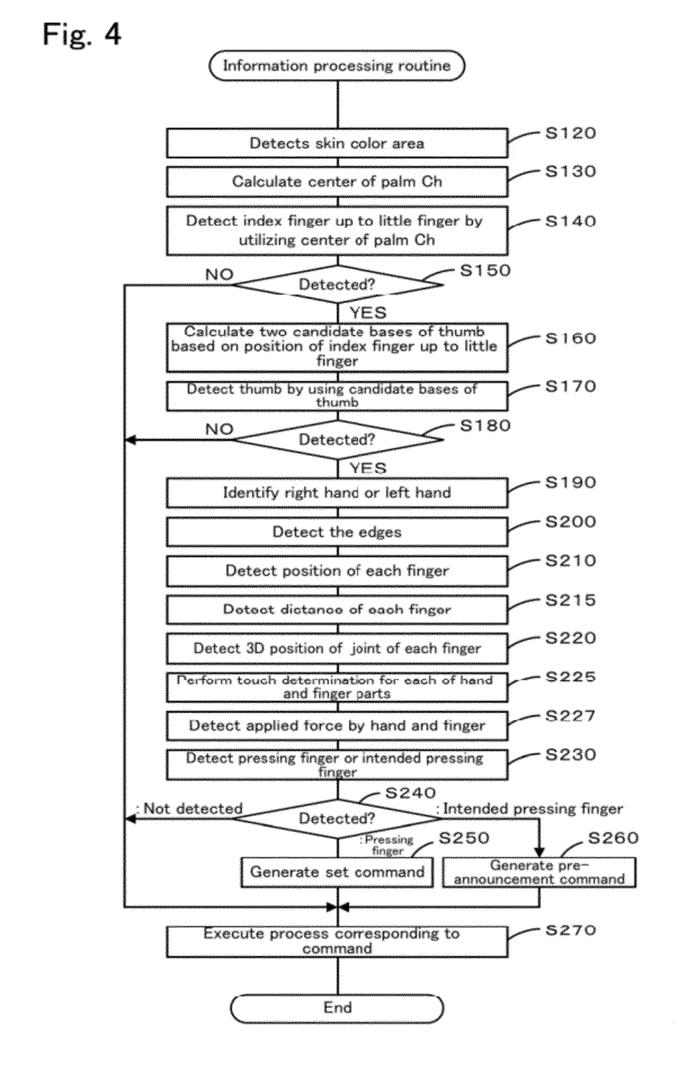

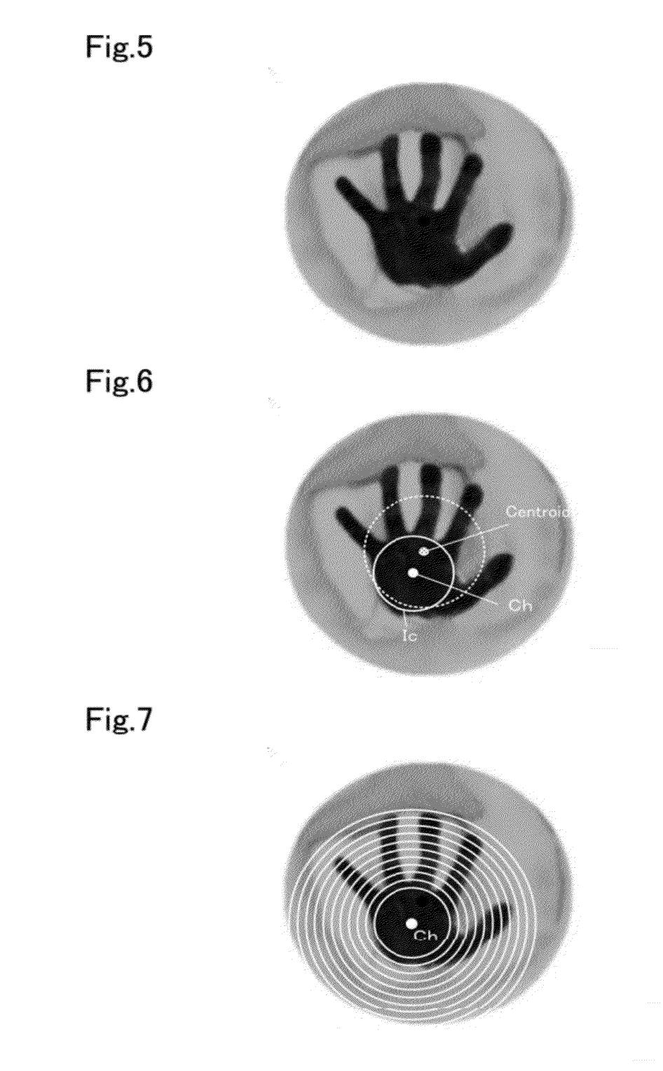

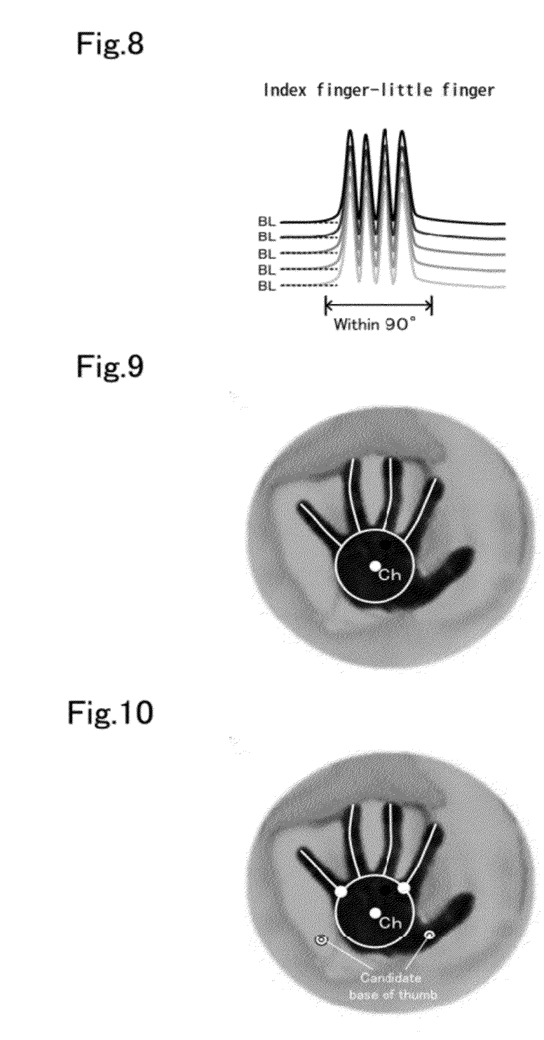

Next, the generation of a command based on digit recognition and the process corresponding to the command will be described. FIG. 4 is a flowchart illustrating an example of an information processing routine. A program for executing the information processing routine is stored in the ROM of the computer 30. FIGS. 5 to 7, 9 to 11, 13, and 14 illustrate images used to explain the respective steps in the information processing routine, and these images are illustrated such that each pixel is represented by likelihood and an image having a higher likelihood is displayed darker while an image having a lower likelihood is displayed brighter. FIG. 8 is a chart to aid recognition of the four fingers, with the horizontal axis representing angle and the vertical axis representing likelihood, and FIG. 12 includes charts to aid recognition of the thumb, with the horizontal axis representing angle and the vertical axis representing likelihood.

The computer 30 executes the information processing routine illustrated in FIG. 4 each time the start flag is turned on in the image capture routine described above. When the routine is started, the computer 30 detects a skin color area in each of the two color images stored in the RAM, that is, the color image obtained when the intensity of the illumination lamps 22 is “high” and the color image obtained when the intensity of the illumination lamps 22 is “low” (step S120). Specifically, first, each of the captured color images is corrected for distortion because the captured color images have been captured through a fisheye lens and have portions with large distortion. Then, the pixel data of each of the corrected color images is converted into pixel data of likelihood on the basis of the likelihood table described above, and a portion having a likelihood greater than a predetermined value is identified as a skin color area. An image (image of likelihood) in which a skin color area has been detected is illustrated in FIG. 5. The predetermined value is a value determined in advance based on the results of a preliminary experiment or the like. Subsequently, the center of the palm Ch is calculated (step S130). Specifically, the centroid of the likelihood of the skin color area is determined, and the center of the palm Ch is searched for from the centroid. The center of the palm Ch is searched for by determining a circle (inscribed circle Ic) that lies inside the skin color area and that maximally overlaps the skin color area, and by identifying the center of the circle as the center of the palm Ch. An image in which the center of the palm Ch has been calculated is illustrated in FIG. 6.

Next, a candidate index finger up to a candidate little finger are detected by utilizing the center of the palm Ch (step S140). Specifically, first, a plurality of concentric circles are drawn from the center of the palm Ch. The smallest circle in the concentric circles is the inscribed circle Ic described above. The radii of the circles are increased in equal steps (of a value set in the range of, for example, 1 to 10 mm) from the radius of the inscribed circle Ic, and a circle whose circumference exceeds the skin color area is identified as the largest circle. This state is illustrated in FIG. 7. Then, for each concentric circle, after the likelihood is scanned along the circumference, the circumference is extended into a line to create a chart with the line being the horizontal axis representing angle and the vertical axis representing likelihood. The obtained chart is illustrated in FIG. 8. The position of each base line BL of the chart corresponds to the radius of a corresponding one of the circles. Each base line BL of the chart exhibits likelihood peaks. The peaks are the closest portions to the standard skin color, and can be regarded as substantially the centers of the widths of the respective digits. Thus, by connecting the peak points that appear at substantially the same angles in the respective base lines BL of the chart, it is possible to create the center lines of the digits. This state is illustrated in FIG. 9. Generally, five center lines of digits are created. Among them, four lines whose widths are within an angle of 90° are regarded as the center lines of a candidate index finger, a candidate middle finger, a candidate ring finger, and a candidate little finger.

Next, it is determined whether or not the four fingers, i.e., the candidate index finger up to the candidate little finger, have been successfully detected (step S150). If these four fingers have not been successfully detected, the routine ends. In this embodiment, even if the entire hand is touching the outer surface 25a of the operation cover 25 or if the entire hand is separated from the outer surface 25a, these four fingers are detectable when the distance between the entire hand and the outer surface 25a is less than or equal to 15 cm. However, when the distance from the outer surface 25a to the entire hand exceeds 15 cm, the four fingers may be undetectable because the hue, brightness, and saturation of the color of the hand are not clearly identifiable. While a description has been given here of 15 cm being a threshold value, the threshold value depends on the diffusion coefficient of the operation cover 25.

Next, if it is determined in step S150 that the four fingers, i.e., the candidate index finger up to the candidate little finger, have been successfully detected, then, two candidate bases of the thumb are estimated using the center of the palm Ch and the bases of two candidate fingers at either side out of the four candidate fingers (step S160). In this estimation, what positional relationship with the base of the thumb, the center of the palm Ch and the bases of two candidate fingers at either side have is determined based on a plurality of pieces of sample data of the human hand, and a candidate base of the thumb is estimated by referring to the positional relationship. Since the index finger is generally longer than the little finger, one of two fingers at either side which has a longer center line may be determined to be the index finger and the one having a shorter center line may be determined to be the little finger. Then, only one candidate base of the thumb on the side nearer the index finger may be selected. However, when the index finger bends, the one having a shorter center line can be the index finger. For this reason, here, it is determined that the index finger and the little finger are not distinguishable, and two candidate bases of the thumb are estimated. This state is illustrated in FIG. 10.

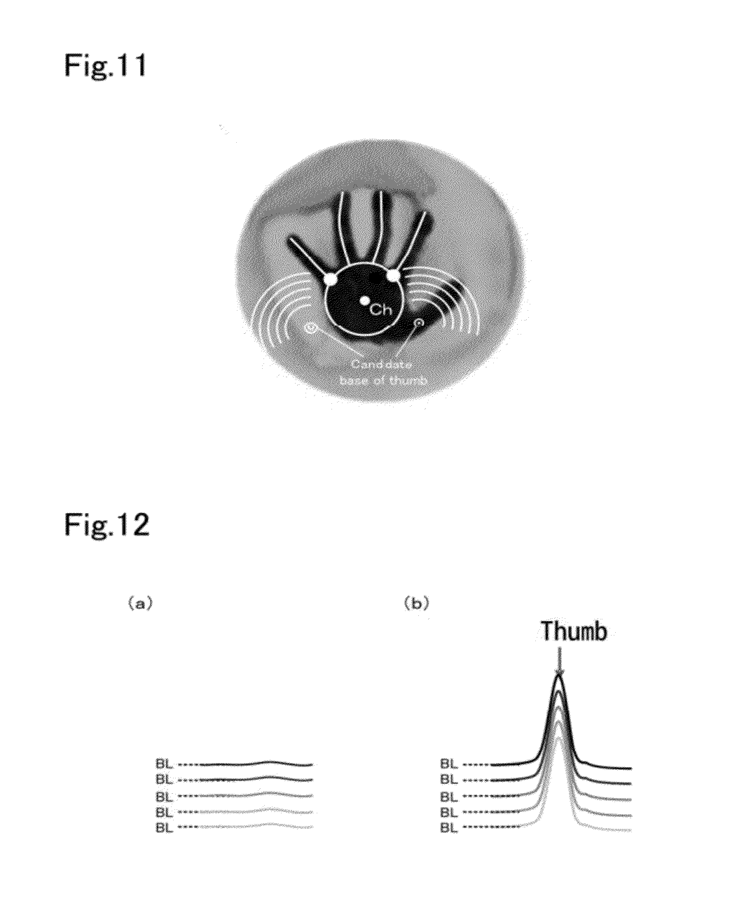

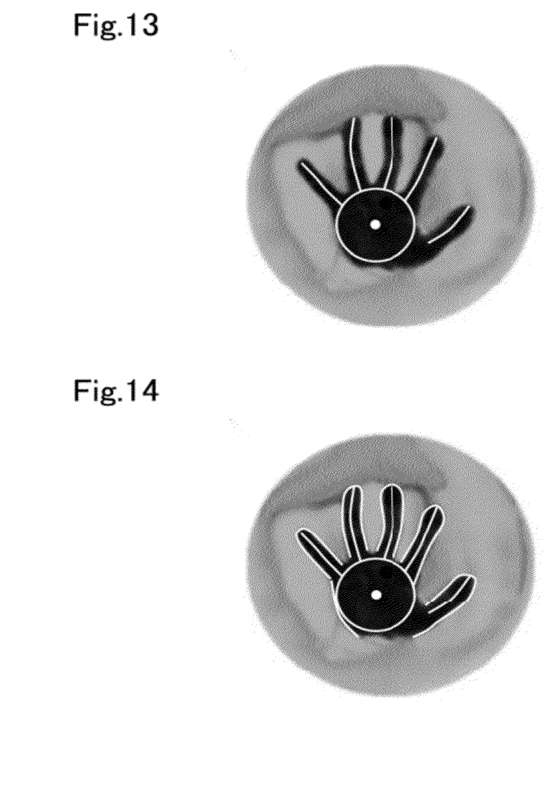

Next, the thumb is detected using the two candidate bases of the thumb (step S170). Specifically, a plurality of concentric circles are drawn so as to have their centers at each of the positions of the candidate bases of the thumb. The radii of the concentric circles are increased in equal steps (of a value set in the range of, for example, 1 to 10 mm). This state is illustrated in FIG. 11. The maximum radius may be equal to the maximum radius obtained when the candidate index finger up to the candidate little finger are detected, or may be 50 to 90% of that maximum radius. The concentric circles may be represented as arcs such that the concentric circles of the left candidate base of the thumb are represented as arcs with a predetermined circumferential angle (of, for example, 100 to 150°) measured counterclockwise from the inscribed circle Ic, and the concentric circles of the right candidate base of the thumb are represented as arcs with a predetermined circumferential angle (of, for example, 100 to 150°) measured clockwise from the inscribed circle Ic. The predetermined circumferential angle may be determined based on, for example, the pieces of sample data described above. Then, for each concentric circle, after the likelihood is determined along the circumference, the circumference is extended into a line to create a chart with the line being the horizontal axis representing angle and the vertical axis representing likelihood. The obtained charts are illustrated in FIG. 12. The position of each base line BL of the charts corresponds to the radius of a corresponding one of the circles. Part (a) of FIG. 12 illustrates a chart based on the left candidate base of the thumb, and part (b) of FIG. 12 illustrates a chart based on the right candidate base of the thumb. It can be seen from FIG. 12 that the right candidate base of the thumb is the actual candidate base of the thumb. Then, similarly to the four fingers, the center line of the thumb is created. This state is illustrated in FIG. 13.

Next, it is determined whether or not the thumb has been successfully detected (step S180). If the thumb has not been successfully detected, the routine ends. In this embodiment, even if the entire hand is touching the outer surface 25a of the operation cover 25 or if the entire hand is separated from the outer surface 25a, the thumb is detectable when the distance between the entire hand and the outer surface 25a is less than or equal to 15 cm. However, when the distance from the outer surface 25a to the entire hand exceeds 15 cm, the thumb may be undetectable because the hue, brightness, and saturation of the color of the hand are not clearly identifiable.

Next, if it is determined in step S180 that the thumb has been successfully detected, then, whether the entire hand that has been detected is the right hand or the left hand is identified (step S190). Specifically, it is possible to determine, as a result of the thumb having been detected, to which of the candidate index finger, the candidate middle finger, the candidate ring finger, and the candidate little finger each of the four fingers detected in step S140 corresponds. Thus, the four fingers are specified, and the right hand or the left hand is identified based on the positional relationship of the four fingers and the thumb. Subsequently, the edges of the respective digits, and the palm are detected (step S200). Specifically, portions where the likelihood is significantly reduced within the image of likelihood of the entire hand are determined, and the obtained portions are detected as the edges of the respective digits and the palm. This state is illustrated in FIG. 14.

Next, the position of each digit is detected (step S210). Which position on the outer surface 25a of the operation cover 25 the tip of digit of each digit is in is detected. A tip of digit can be determined based on, for example, the edges and the center line of a digit in FIG. 14.

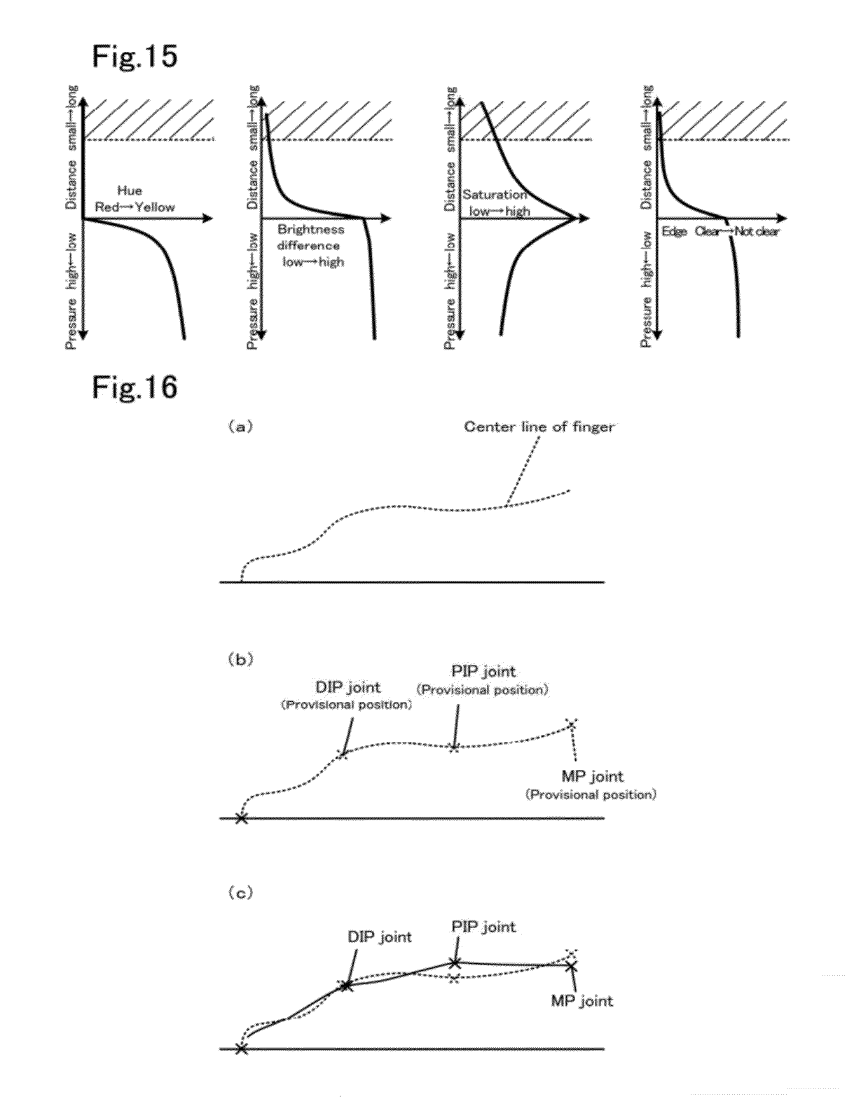

Next, the distance of each digit is estimated (step S215). Specifically, a distance or a pressure is estimated using hue, brightness difference, and saturation obtained after the RGB values of the respective pixels are converted into HSV values and also using the edges described above. As a result of examination, it is found that the hue, brightness difference, saturation, and edge of a digit change in a manner illustrated in graphs in FIG. 15 in accordance with the distance from the outer surface 25a to the digit and the pressure applied to the outer surface 25a by the digit. In FIG. 15, shaded regions are regions where the distance from the outer surface 25a to a digit is too long to recognize the digit. Hue becomes red while a digit is separated from the outer surface 25a, is still red when a digit touches the outer surface 25a, and thereafter becomes yellow as the pressure increases. The brightness difference is determined by subtracting the value of brightness of an image obtained when the intensity of the illumination lamps 22 is “low” from the value of brightness of an image obtained when the intensity of the illumination lamps 22 is “high”. The brightness difference has a small value when a digit is separated far from the outer surface 25a, rapidly increases when the digit is about 5 mm above the outer surface 25a, and is kept substantially constant at a large value regardless of pressure after the digit touches the outer surface 25a. Saturation gradually increases as a digit approaches the outer surface 25a, exhibits a peak value when the digit touches the outer surface 25a, and gradually decreases as pressure increases. For edge clarity, the edge is not clear when a digit is separated far from the outer surface 25a, increasingly becomes clear when the digit is about 5 mm above the outer surface 25a, and is kept clear regardless of pressure after the digit touches the outer surface 25a. From the above results, the distance from a digit to the outer surface 25a when the digit is separated from the outer surface 25a can be estimated using at least one of the brightness difference, saturation, and edge clarity. Hue, saturation, and edge clarity, to which coefficients are applied in accordance with the intensity of the illumination lamps 22, are calculated for each frame of an image. Brightness difference is determined based on a color image obtained when the intensity of the illumination lamps 22 is “high” and a color image obtained when the intensity of the illumination lamps 22 is “low”.

Next, the position of a joint of each digit is detected (step S220). Specifically, first, the distance (height) of the center line of each digit from the outer surface 25a is estimated based on parameters such as saturation and brightness obtained after the RGB values of the respective pixels are converted into HSV values, and the center line of each digit is represented in a three-dimensional space. A conceptual diagram of this state is illustrated in part (a) of FIG. 16. Then, for each digit, the length of the center line represented in the three-dimensional space is equally divided into three segments, and, as illustrated in part (b) of FIG. 16, provisional positions of the DIP joint (first joint), the PIP joint (second joint), and the MP joint (third joint) are determined. Subsequently, optimization is performed using the inverse kinematics model and a least square method so that the errors of the provisional positions of the respective joints become minimum, and, as illustrated in part (c) of FIG. 16, the DIP joint, the PIP joint, and the MP joint of each digit are determined. The detection of joint positions in this manner facilitates the detection of a pressing area of a digit, enables the detection of the length of a digit regardless of whether the digit bends or straightens, and enables the detection of actions such as scratching, stroking, and pinching.

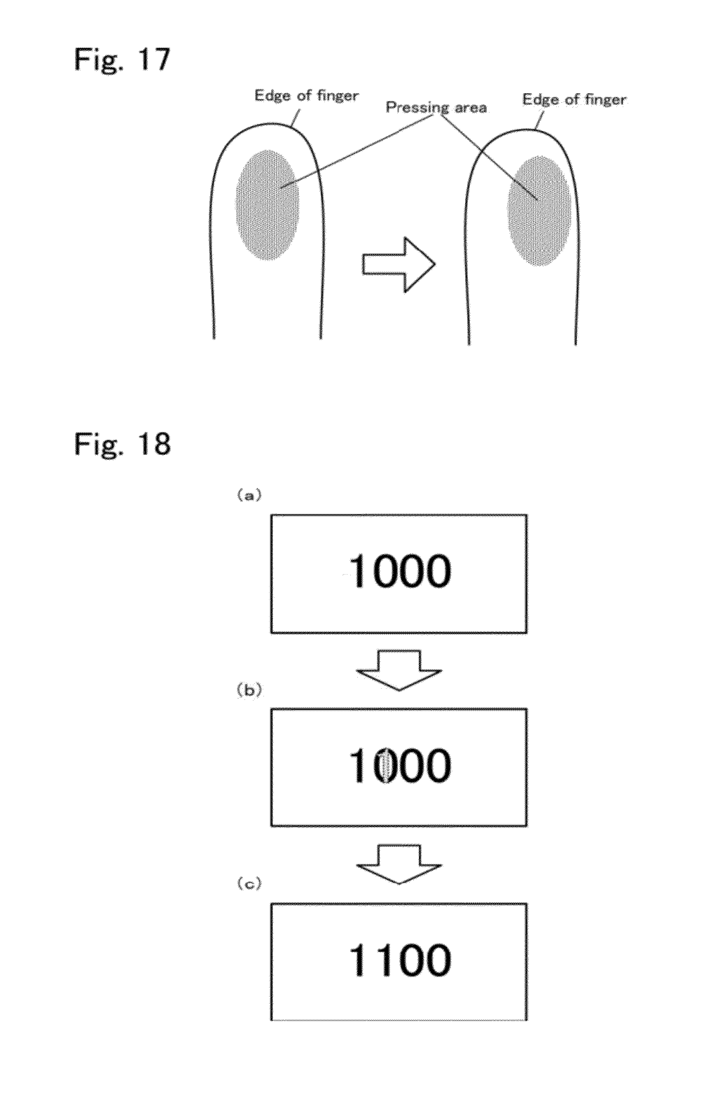

Next, touch determination is performed for each of the hand and digit parts (step S225). The hand and digit part as used here is assumed to be a set of regions obtained by dividing the palm and the digits by each of the MP joint, the IP joint, the PIP joint, and the DIP joint. It is found that, in the configuration as in FIG. 2, at the moment when the hand and digits and the like touch the outer surface 25a, the brightness of the touched area rapidly increases. In this embodiment, which enables individual recognition and tracking of the hand and digit parts while the hand and digits and the like are not touching the outer surface 25a, successive monitoring of changes in the brightness of each of the hand and digit parts enables accurate determination of a touch. When a touch of a hand and digit part is detected, the force applied to the outer surface 25a by the hand and digits is estimated (step S227). The magnitude of the pressure applied to the outer surface 25a by a digit can be estimated by at least one of the hue and saturation. In this case, it is determined, based on the magnitude of the pressure, whether a touch with a tip of digit is a touch intended by a user to perform an input operation or is an accidental touch. When pressure is applied with a rolling digit, as illustrated in FIG. 17, the positional relationship between the edge and the pressing area of the digit is shifted, and therefore the magnitude and direction of shear force and the magnitude of pressure at that time can be estimated. In step S227, a pressure and a shear force are output for tip of digits while a pressure distribution is output for the other hand and digit parts. The pressing area has a yellow hue because pressing causes the flow of blood through the digit to change.

Next, a pressing digit or an intended pressing digit is detected (step S230). In the detection of a pressing digit, since the pressure of each digit can be obtained instep S220, a digit that applies pressure to the outer surface 25a is determined to be a pressing digit. An intended pressing digit is detected in the following way: First, it is recognized, based on the distance of each digit calculated in the previous information processing routine, the distance of each digit calculated in the current information processing routine, and the interval time (the difference between the time at which the previous color image was captured and the time at which the current color image was captured), whether each digit is touching the outer surface 25a, is approaching the outer surface 25a, or is leaving the outer surface 25a. If there is a digit approaching the outer surface 25a, this digit is determined to be an intended pressing digit. If there are a plurality of digits approaching the outer surface 25a, one of the approaching digits which has the smallest distance to the outer surface 25a is identified as an intended pressing digit. If there are a plurality of digits having equivalent distances, one of the digits which has the highest approaching speed is identified as an intended pressing digit. The approaching speed can be easily calculated based on the distance of each digit calculated in the previous information processing routine, the distance of each digit calculated in the current information processing routine, and the interval time. A digit having the smallest distance to the outer surface 25a or a digit having the highest approaching speed may be searched for by using the absolute heights of digits or using the relative heights of digits. In this regard, preferably, the relative heights of digits are used because the relative heights of digits are less affected by individual differences (that is, differences between operators) than the absolute heights of digits. When the absolute heights of digits are used, preferably, the absolute heights are determined based on changes in the clarity of the edge of the digits. This is because the changes in the clarity of the edge of the digits are comparatively less affected by individual differences.

Next, it is determined whether or not a pressing digit or an intended pressing digit has been detected (step S240). If none of them has been successfully detected, the routine ends. If a pressing digit has been detected, a set command is generated based on the detected digit (step S250). In this case, a set command may be generated based on the pressing digit and a position on the outer surface 25a which is pressed by the pressing digit. If an intended pressing digit has been detected, a pre-announcement command is generated based on the intended pressing digit (step S260). In this case, a pre-announcement command may be generated based on the intended pressing digit and an estimated position on the outer surface 25a which is to be pressed by the intended pressing digit.

Next, the process corresponding to the command is executed (step S270), and then the routine ends. It is assumed here that the ROM of the computer 30 has stored therein a number output program as a process executing program. The number output program is a program for increasing the digit in the thousands place by 1 each time the index finger of the right hand presses the outer surface 25a, increasing the digit in the hundreds place by 1 each time the middle finger presses the outer surface 25a, increasing the digit in the tens place by 1 each time the ring finger presses the outer surface 25a, and displaying the result on the display 40. In this case, if the outer surface 25a is pressed once with the index finger, the index finger is a pressing digit, and a set command to display “1000” is generated in step S250. In accordance with the set command, “1000” is displayed on the display 40 (see part (a) of FIG. 18). After that, if the middle finger is approaching the outer surface 25a from a position separated from the outer surface 25a, the middle finger is regarded as an intended pressing digit, and a pre-announcement command for pre-announcing that “1” will be displayed in the hundreds place is generated in step S260. In accordance with the pre-announcement command, “1” is displayed in a discernible faint color so as to overlap “0” in the hundreds place within “1000” displayed on the display 40 (see part (b) of FIG. 18). After that, when the middle finger presses the outer surface 25a, the middle finger becomes a pressing digit, and a set command to display “1” in the hundreds place is generated in step S250. In accordance with the set command, “1100” is displayed on the display 40 (see part (c) of FIG. 18).

According to the information processing apparatus 10 of this embodiment which has been described in detail, an operator is able to know what process will be executed if the operator continues pressing the operation cover 25 with their digit while making their digit more closely approach the outer surface 25a of the operation cover 25. Therefore, operability for the operator is improved.

Additionally, a pressing digit and an intended pressing digit are recognized by utilizing a predetermined relationship between at least one parameter out of the brightness difference, saturation, and edge clarity of a digit and the distance from the outer surface 25a of the operation cover 25 to the digit and also utilizing the interval time during which a color image is captured. Therefore, whether or not a digit is pressing the outer surface 25a and whether or not a digit is approaching the outer surface 25a can be accurately determined.

In addition, when there are a plurality of approaching digits, one of the approaching digits which has the smallest distance to the outer surface 25a is regarded as an intended pressing digit. Further, when there are a plurality of digits having equivalent distances, the approaching speed of each of the approaching digits is determined, one of the digits having the highest approaching speed is regarded as an intended pressing digit. Therefore, a digit with which the operator is to press the outer surface of the operation cover in the next operation can be accurately determined.

In addition, pixel data of a color image of the entire human hand is converted into likelihood that is defined to increase as hue becomes closer to the standard skin color or as brightness and saturation increase, and the hand and digits are recognized from a likelihood image created based on the likelihood. Therefore, a likelihood image of a hand exhibits a high value around the center lines of the digits and around the center of the palm regardless of whether touching or not. Consequently, for example, even if two digits are placed together with any space therebetween, each digit can be easily recognized by keeping track of pixels having peaks of likelihood.

In addition, the operation cover 25 is formed in a dome shape, and has the inner surface 25b that is a smooth surface and the outer surface 25a that is a surface having small irregularities like a ground glass. Thus, the operation cover 25 can be easily touched with the entire hand. Additionally, when a digit is touching the operation cover 25, a clear image of the digit can be obtained, and, when a digit is separated from the operation cover 25, a blurred image of the digit can be obtained. Therefore, both states are easily distinguished from each other.

It is to be understood that the present invention is not limited to the foregoing embodiment, and may be embodied in a variety of modes within the technical scope of the present invention.

For example, in the number output program of the foregoing embodiment, there is no problem about which position on the outer surface 25a a digit presses. However, even when the same digit presses the outer surface 25a, a different command may be generated depending on the position the digit presses. Specifically, a position on the outer surface 25a which has been pressed by a pressing digit may be calculated, and a set command may be generated based on the pressing digit and the pressed position. Also, an estimated position on the outer surface 25a which is estimated to be pressed by an intended pressing digit may be determined, and a pre-announcement command may be generated based on the intended pressing digit and the estimated position. This can increase the number of commands compared with a case where a set command and a pre-announcement command are generated irrespective of the position on the outer surface 25a.

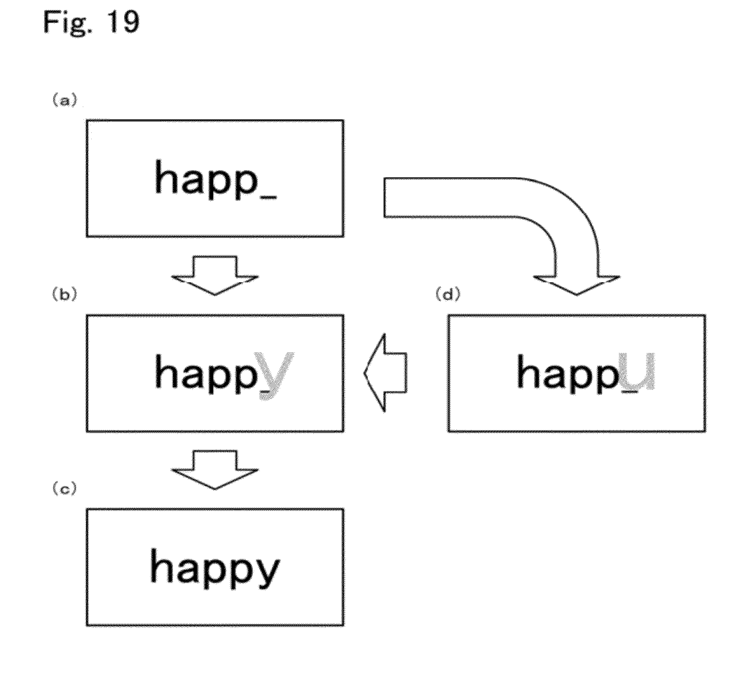

In the foregoing embodiment, when a process corresponding to the command is executed in step S270, a number output program is executed. Alternatively, a character output program may be executed. Specifically, a virtual keyboard is set on the outer surface 25a of the operation cover 25. The virtual keyboard has keys assigned in accordance with positions on the outer surface 25a. Here, even if the same position has been pressed, an input signal of a different key is generated depending on which digit has pressed the position. Now, it is assumed that, as illustrated in part (a) of FIG. 19, “happ” is being displayed on the display 40. In this state, if the index finger of the right hand is made to approach the position of the virtual “y” key on the outer surface 25a from above the position, the index finger is regarded as an intended pressing digit and the position of the virtual “y” key is regarded as an estimated position. A pre-announcement command for pre-announcing that “y” will be displayed at the cursor position is generated in step S260. In accordance with the pre-announcement command, “y” is displayed on the display 40 with a different font size and a different color from those of the other characters (see part (b) of FIG. 19). In this case, the font size and the color are changed in accordance with the distance between the intended pressing digit and the outer surface 25a. Therefore, if the distance from the intended pressing digit to the outer surface 25a is large (for example, 2 to 3 cm), “y” is displayed with a large font size and a discernible faint color. If the distance is small (for example, 1 to 2 cm), “y” is displayed with a slightly large font size and a slightly faint color. After that, when the index finger of the right hand presses the position of the virtual “y” key on the outer surface 25a, the middle finger becomes a pressing digit, and a set command to input “y” is generated in step S250. In accordance with the set command, “y” is input, on the right side of “happ” on the display 40 (see part (c) of FIG. 19). In contrast, if the index finger of the right hand is made to more closely approach the position of the virtual “u” key from above the position by mistake, the index finger is regarded as an intended pressing digit, and the position of the virtual “u” key is regarded as an estimated position. Then, a pre-announcement command for pre-announcing that “u” will be displayed at the cursor position is generated in step S260. In accordance with the pre-announcement command, “u” is displayed on the display 40 with a different font size and a different color from those of the other characters (see part (d) of FIG. 19). Therefore, the operator is able to recognize that “u” will be input if the index finger of the right hand presses the same position, and is able to place the index finger in the position of the virtual “y” key. Specifically, after that, the operator moves the index finger of their right hand above the position of the virtual “y” key, and presses this position. Accordingly, the display state on the display 40 is changed in a manner as in part (b) of FIG. 19 and part (c) of FIG. 19. Instead of a character being output on the display 40, audio may be output from a speaker. In this case, when a digit actually presses a key, a low-pitched sound may be output to indicate the key. When a digit is approaching a key, a high-pitched sound may be output to indicate the key.

The virtual keyboard may be placed so that a character group to be operated with the index finger, a character group to be operated with the middle finger, and a character group to be operated with the ring finger overlap. The virtual keyboard may also be configured to keep track of the position of the entire hand placed on the operation cover 25. For example, in a state where the entire right hand is in light contact with the outer surface 25a of the operation cover 25, the computer 30 recognizes the digits but does not generate a key input signal, and recognizes the positions of the digits as home positions. For example, the position of the index finger of the right hand is recognized to be at the “J” key, the middle finger of the right hand at the “K” key, the ring finger of the right hand at the “L” key, and the little finger of the right hand at the “;” key. The virtual keyboard is set over the outer surface 25a of the operation cover 25 so that the above positions are located at the correct positions. This enables the operator to perform keyboard input without having to pay attention to the positional relationship between the operation cover 25 and their hand. The computer 30 may display a message on the display 40, such as “Please place your hand on the dome in a comfortable way. Calibration will start in 5 seconds time,” before recognizing the home positions. Alternatively, a key layout that fits the size of the user's hand may be automatically set using the length of each digit output in step S220.

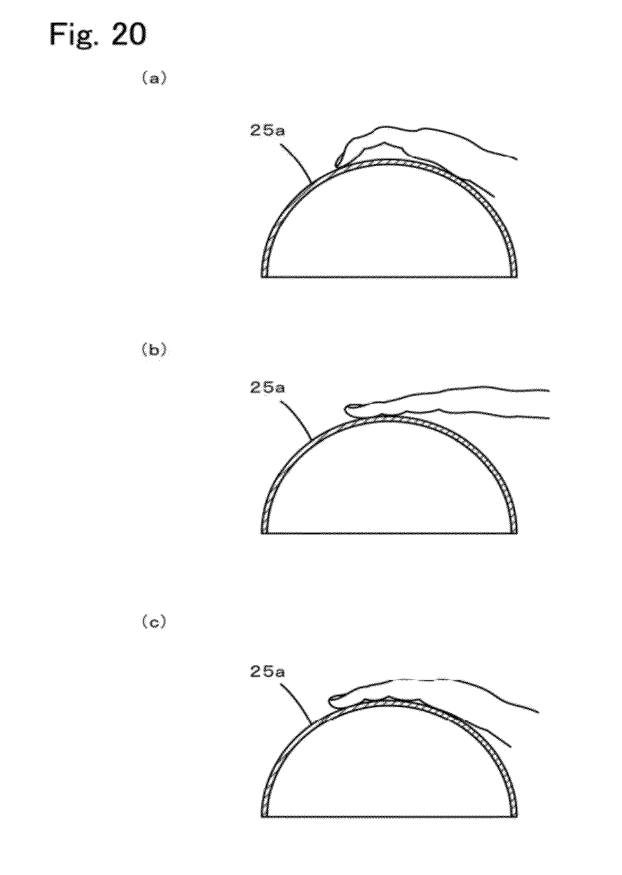

In the foregoing embodiment, it may be determined whether an input mode has been entered based on the positional relationship between a digit or a palm and the outer surface 25a of the operation cover 25. Specifically, it may be determined that a character input mode has been entered when, as in part (a) of FIG. 20, the tips of digit of the respective digits and the palm are touching the outer surface 25a but the inner surfaces of the digits are not in contact with the outer surface 25a; a 2D (two-dimensional) input mode has been entered when, as in part (b) of FIG. 20, the tips of digit of the respective digits are touching the outer surface 25a but the palm is not in contact with the outer surface 25a; and a 3D (three-dimensional) input mode has been entered when, as in part (c) of FIG. 20, the entirety of the respective digits and the palm are touching the outer surface 25a. The above determination may be based on the distance from the DIP joint, the PIP joint, the MP joint of each digit to the outer surface 25a or based on the distance between the palm and the outer surface 25a. Therefore, the use of the operation cover 25 enables an input operation to be performed in a plurality of input modes. Thus, there is no need to switch among a character input device (for example, a keyboard), a 2D input device (for example, a mouse), and a 3D input device. The setting of the virtual keyboard described above may be based on the assumption that a character input mode has been set.

In the foregoing embodiment, the operation cover 25 is formed in a dome shape. However, the shape of the operation cover 25 is not limited to a dome shape, and may be, for example, a spherical or flat shape.

In the foregoing embodiment, the information processing routine is started each time the start flag is turned on in order to use both a color image captured when the intensity of the illumination lamps 22 is “high” and a color image captured when the intensity of the illumination lamps 22 is “low”. However, the information processing routine may be started each time a color image is captured without switching the intensity of the illumination lamps 22. In this case, in a case where the distance between a digit and the outer surface 25a is determined when the digit is separated from the outer surface 25a in step S220, the distance may be estimated by using at least one of saturation and edge clarity without using brightness difference.

In the foregoing embodiment, the processing of steps S120 to S210 is performed using both a color image captured when the intensity of the illumination lamps 22 is “high” and a color image captured when the intensity of the illumination lamps 22 is “low”, and the hand and digits are recognized. However, when the intensity of the illumination lamps 22 is “low” (also when the illumination lamps 22 are turned off), instead of the processing of steps S120 to S210 being performed, matching may be performed using each of the hand and digit parts detected immediately before the processing, i.e., when the intensity of the illumination lamps 22 is “high”, as a template to recognize the hand and digit parts when the intensity of the illumination lamps 22 is “low”.

In the foregoing embodiment, the intensity of the illumination lamps 22 is repeatedly switched. The illumination lamps 22 may be repeatedly switched between on and off. In this case, the calculation of hue, saturation, and edge clarity in step S220 is performed only when the illumination lamps 22 is turned on.

### INDUSTRIAL APPLICABILITY

An integrated input interface according to the present invention can be used in a personal computer, a game computer, and the like.

What is claimed is:

1. An integrated input interface comprising:
an image capturing device capable of capturing a color image;
a light-transmissive operation cover disposed so as to cover the image capturing device, the operation cover having an outer surface which can be touched by an operator with an entire hand of the operator;
a command generator for recognizing a pressing digit that has pressed the outer surface, based on a color image of the entire hand which has been captured by the image capturing device, and generating a set command based on the pressing digit, and also for recognizing an approaching digit that is approaching the outer surface, based on a color image of the entire hand which has been captured by the image capturing device, regarding the approaching digit as an intended pressing digit, and generating a pre-announcement command based on the intended pressing digit; and
a processor for executing a process corresponding to the set command when the command generator generates the set command, and for executing a pre-announcement process for pre-announcing that the process corresponding to the set command is to be executed when the command generator generates the pre-announcement command.

2. The integrated input interface according to claim 1, wherein the command generator recognizes the pressing digit and the intended pressing digit by utilizing a predetermined relationship between at least one parameter out of a brightness, saturation, and edge clarity of a digit and a distance from the outer surface to the digit and also by utilizing an interval time during which the color image is captured.

3. The integrated input interface according to claim 1, wherein the command generator calculates a position on the outer surface which has been pressed by the pressing digit, and generates a set command based on the pressing digit and the position, and wherein the command generator determines an estimated position on the outer surface which is estimated to be pressed by'the intended pressing digit, and generates a pre-announcement command based on the intended pressing digit and the estimated position.

4. The integrated input interface according to claim 1, wherein when there are a plurality of the approaching digits, the command generator determines a distance between each of the approaching digits and the outer surface, and regards a digit having the smallest distance as the intended pressing digit, or calculates a predicted touch time based on an approaching speed of each of the approaching digits, and regards a digit having the shortest predicted touch time as the intended pressing digit.

5. The integrated input interface according to claim 4, wherein when there are a plurality of the approaching digits having equivalent distances to the outer surface, the command generator determines an approaching speed of each of the approaching digits, and regards a digit having the highest approaching speed as the intended pressing digit.

6. The integrated input interface according to claim 1, further comprising:
an output device capable of outputting at least a character,
wherein the processor sets a virtual keyboard over the operation cover; when the command generator generates the set command, the processor outputs a character on the virtual keyboard corresponding to a pressing digit and a pressed position included in the set command to the output device in a predetermined form; and when the command generator generates the pre-announcement command, the processor outputs a character on the virtual keyboard corresponding to an intended pressing digit and an estimated position included in the pre-announcement command to the output device in a form different from the predetermined form.

7. The integrated input interface according to claim 1, wherein the command generator converts pixel data of a color image of an entire human hand which has been captured by the image capturing device into likelihood defined to increase as hue becomes closer to a standard skin color and as brightness and saturation increase, and recognizes each digit from a likelihood image created based on the likelihood.

8. The integrated input interface according to claim 7, wherein when recognizing each digit from the likelihood image, the command generator searches for pixels having peaks of likelihood on a circumference of each of a plurality of concentric circles drawn so as to have their centers at a predetermined point on a palm in the likelihood image, creates four finger center lines connecting pixel groups having peaks of likelihood which are arranged radially outward from the predetermined point, calculates two candidate base positions of the thumb based on two finger center lines at either side out of the four finger center lines, searches for a pixel having a peak of likelihood on a circumference of each of a plurality of concentric circles drawn so as to have their centers at each of the two candidate base positions of the thumb, recognizes a digit center line connecting the searched pixels having peaks of likelihood to be the thumb, and assigns, based on the recognized thumb, the four finger center lines to an index finger, a middle finger, a ring finger, and a little finger.

9. The integrated input interface according to claim 1, wherein the operation cover is formed in a dome shape, and has an inner surface that is a smooth surface, and the outer surface that is a surface having small irregularities like a ground glass.
